(19) United States
(12) Patent Application Publication
(10) Pub. No.: US 2005/0013060 A1
(43) Pub. Date: Jan. 20, 2005

(54) Magnetoresistive sensor

(75) Inventor: Hubert Grimm, Mommenheim (DE)

Correspondence Address: William D. Gill;IBM Corporation, Intellectual Property Law, 5600 Cottle Road (L2PA/010), San Jose, CA, 95193, US

(73) Assignee: International Business Machines Corporation, Armonk, NY (US)

(21) Appl. No.: 10/890,863

(22) Filed: Jul. 13, 2004

(30) Foreign Application Priority Data
Jul. 14, 2003 (DE) 03015974.3

(51) Int. Cl. G11B 5/39

(52) U.S. Cl. 360/324

(57) ABSTRACT

The present invention relates to a magnetoresistive sensor comprising a multilayer stack of at least first and second ferromagnetic layers, the first and second ferromagnetic layers being spaced apart by a non-ferromagnetic spacing layer, and further comprising a ferromagnetic element creating magnetoelastic anisotropy by which a magnetic flux to which the stack is subjected is amplified when the operating temperature of the stack increases.

### FIELD OF THE INVENTION

This invention relates generally to the field of magnetoresistive sensors, and more particularly to multilayer magnetoresistive sensors, such as giant magnetoresistive multilayer sensors.

### BACKGROUND AND PRIOR ART

A conventional magnetoresistive sensor operates on the basis of the anisotropic magnetoresistive effect. Such conventional magnetoresistive sensors provide an essentially analogue signal output wherein the resistance and hence signal output is directly related to the strength of the magnetic field being sensed.

A different and more pronounced magnetoresistance, called giant magnetoresistance (GMR), has been observed in a variety of magnetic multilayered structures, the essential feature being at least two ferromagnetic metal layers separated by a non-ferromagnetic metal layer. This GMR effect has been found in a variety of systems, such as Fe/Cr, Co/Cu, or Co/Ru multi-layers exhibiting strong antiferromagnetic coupling of the ferromagnetic layers.

This GMR effect has also been observed for these types of multilayer structures, but wherein the ferromagnetic layers have a single crystalline structure and thus exhibit uniaxial magnetic anisotropy, as described in U.S. Pat. No. 5,134,533 and by K. Inomata, et al., J. Appl. Phys. 74 (6), Sep. 15, 1993.

The physical origin of the GMR effect is that the application of an external magnetic field causes a reorientation of all of the magnetic moments of the ferromagnetic layers. This in turn causes a change in the spin-dependent scattering of conduction electrons and thus a change in the electrical resistance of the multilayered structure.

The resistance of the structure thus changes as the relative alignment of the magnetizations of the ferromagnetic layers changes. Magnetoresistive sensors based on the GMR effect also provide an essentially analogue signal output. A magnetoresistive sensor is known for example from U.S. Pat. No. 5,585,986.

FIG. 1 shows a schematic sectional view of a prior art GMR sensor. The sensor includes a substrate 101, a seed layer 103 formed on the substrate 101 and a stack 110 of alternating ferromagnetic layers and non-ferromagnetic metal spacer layers formed on seed layer 103.

There are nine magnetic layers 121-129 separated by eight non-ferromagnetic metal layers 131-138. The sensor includes a protective or capping layer 140 and electrical leads 150, 152. The leads 150, 152 provide electrical connection to a current source 160 and a signal sensing circuit 162.

The sensor's multilayer stack 110 is preferably formed from ferromagnetic layers 121-129 of cobalt (Co) or permalloy (NiₓFe₁₋ₓ), and non-ferromagnetic metallic spacer layers 131-138 of copper (Cu). Alternative ferromagnetic materials are binary and ternary alloys of Co, nickel (Ni) and iron (Fe) and alternative non-ferromagnetic metals are silver (Ag), gold (Au) and alloys of Cu, Ag and Au.

Such multilayer structures exhibit GMR in that the ferromagnetic layers are anti-ferromagnetically coupled across the spacer layers and the relative alignments of the magnetizations of the ferromagnetic layers vary in the presence of an external magnetic field.

The stack 110 is a crystalline multilayer grown in such a manner that each of the ferromagnetic layers 121-129 exhibits an intrinsic in-plane uniaxial magnetic anisotropy. This means that in the absence of an external magnetic field the crystalline structure of each ferromagnetic layer induces the magnetization to be aligned either parallel or antiparallel to a single axis. Molecular beam epitaxy (MBE) can be used to prepare the crystalline multilayer. However, it has been shown that a crystalline multilayer can be formed by the simpler process of sputter deposition, as described for example by Harp and Parkin, Appl. Phys. Lett. 65 (24), 3063 (Dec. 12, 1994).

As shown by arrows 170-174 and oppositely directed arrows 180-183, alternate ferromagnetic layers 121-129 have their magnetizations oriented antiparallel in the absence of an external magnetic field. This antiparallel alignment is due to the intrinsic uniaxial anisotropy and the antiferromagnetic coupling across the Cu spacer layers 131-138.

The Cu (or other spacer layer) thickness has to be chosen to lie within limited ranges for which the permalloy, Co, or related ferromagnetic layers are coupled anti-ferromagnetically. For such ranges of spacer layer thickness GMR is observed.

FIG. 2 is illustrative of the temperature dependency of such a prior art magnetoresistive sensor. As apparent from FIG. 2 the sensitivity of the sensor deteriorates when the operating temperature of the sensor increases.

FIG. 3 shows a prior art sensor arrangement including magnetoresistive sensors 200 and 202 of the type as shown in FIG. 1 as well as flux guides 204. The flux guides 204 serve to guide the magnetic flux to the sensors 200 and 202.

### SUMMARY OF THE INVENTION

The present invention provides for a magnetoresistive sensor having a multi-layer stack of at least first and second ferromagnetic layers, whereby the ferromagnetic layers are spaced apart by non-ferromagnetic spacing layers. The ferromagnetic layers themselves or flux guide elements serve to create a magnetoelastic anisotropy by which a magnetic flux to which the multi-layer stack is subjected is amplified when the operating temperate of the sensor increases. The magnetoelastic anisotropy, which is also referred to as magnetostriction, has the effect that the magnetic flux is amplified such that the temperature dependent sensitivity of the sensor is compensated.

In accordance with a preferred embodiment of the invention the multi-layer stack is a spin valve structure whereby the magnetic field amplification is caused by magnetostriction of the free layer of the spin valve structure when the operating temperature is increased.

In accordance with a further preferred embodiment of the invention the multi-layer stack of the magnetoresistive sensor is formed on a substrate. The substrate and the multi-layer stack have different thermal expansion coefficients such that mechanical stress is created, when the temperature increases. This invokes magnetostriction such that the magnetic flux is amplified.

In accordance with a further preferred embodiment of the invention the magnetoresistive sensor has one or more flux guides. The flux guides have one or more flux guide stripes which are arranged in parallel or perpendicular to the layers of the stack. Preferably the flux guides are deposited on the same substrate as the multi-layer stack. Again a temperature increase causes a mechanical stress between the flux guide stripes and the substrate which in turn causes magnetostriction and amplification of the magnetic flux.

A parallel arrangement of the flux guide stripes is used if a ferromagnetic material for the flux guide stripes is used which has positive magnetostriction. A mechanical compression stress which is caused by an increase of the operating temperature causes an amplification effect of the sensed magnetic field in a direction perpendicular to the flux guide stripes.

A perpendicular arrangement of the flux guide stripes is used if a ferromagnetic material for the flux guide stripes is used which has negative magnetostriction. A mechanical compression stress which is caused by an increase of the operating temperature causes an amplification effect of the sensed magnetic field in a direction perpendicular to the flux guide stripes.

In accordance with a further preferred embodiment of the invention permalloy is used as a ferromagnetic material for the ferromagnetic layers of the stack and/or the flux guides, and in particular the flux guide stripes. Preferably a nickel-iron composition is used with below 81.4% nickel if the flux guide stripes are arranged in parallel to the ferromagnetic layers of the magnetoresistive sensor.

### BRIEF DESCRIPTION OF THE DRAWINGS

In the following preferred embodiments of the invention will be described in greater detail by making reference to the drawings in which:

FIG. 1 is a schematic sectional view of a prior art magnetoresistive sensor;

FIG. 2 is illustrative of the temperature dependency of the sensitivity of a prior art magnetoresistive sensor;

FIG. 3 is illustrative of a prior art sensor arrangement including flux guides;

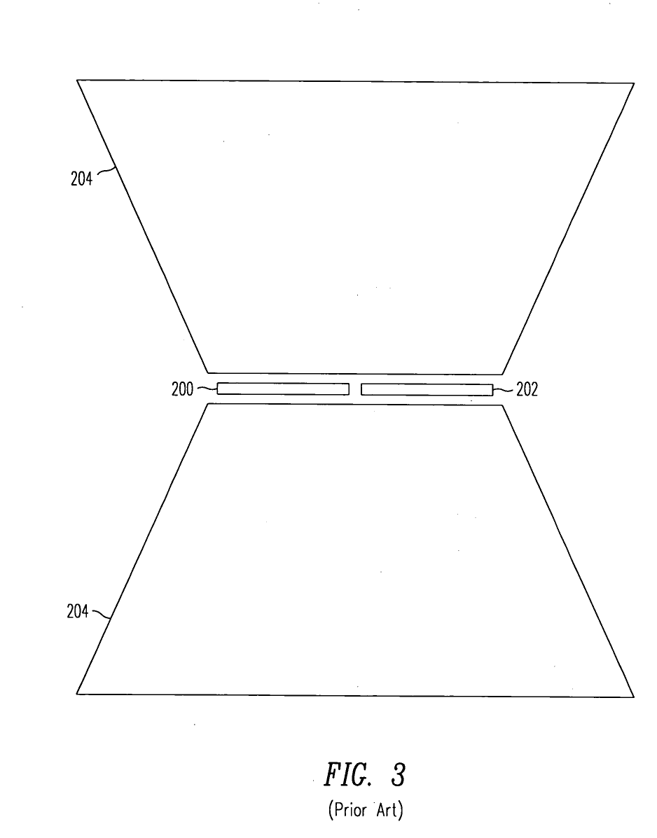

FIG. 4 is a schematic sectional view of the magnetoresistive sensor according to the present invention;

FIG. 5 is illustrative of a sensor arrangement including flux guides in accordance with an embodiment of the present invention;

FIG. 6 is illustrative of the amplification effect of the magnetostriction.

### DETAILED DESCRIPTION

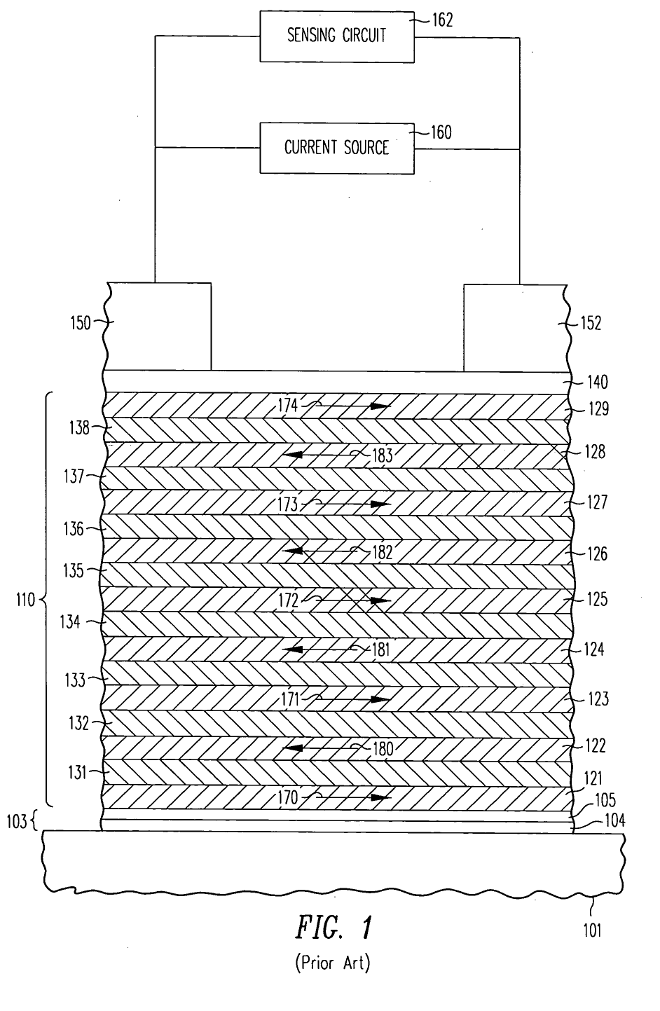

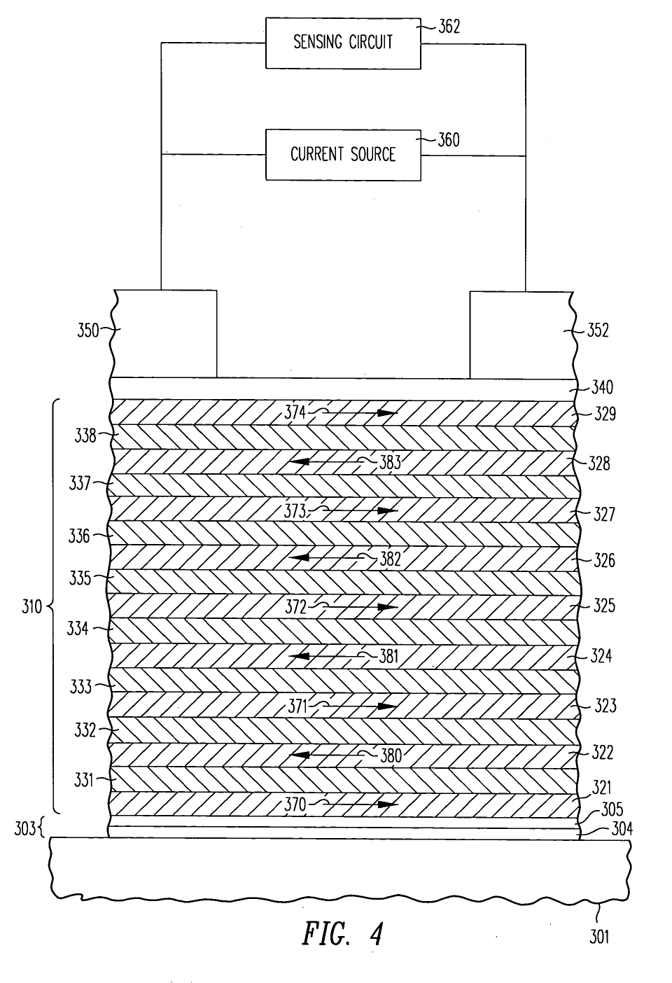

FIG. 4 shows a schematic sectional view of an embodiment of a magnetoresistive sensor of the invention. Reference numerals designating like elements as in the embodiment of FIG. 1 are designated by like reference numerals having added 200.

In contrast to the prior art the ferromagnetic layers 321-329 are composed of a material creating a magnetostriction effect when the operating temperature of the sensor increases such that the magnetic flux to which the sensor is subjected increases. This can be accomplished by using permalloy for the ferromagnetic layers 321-329 with below 81.4% nickel. The magnetoelastic anisotropy which is thus created has an amplification effect on the magnetic flux which compensates a decreasing sensor sensitivity when the operating temperature of the sensor increases.

The magnetostriction effect is caused by different thermal expansion coefficients of substrate 301 and the ferromagnetic and non-ferromagnetic layers of which multi-layer stack 310 is composed.

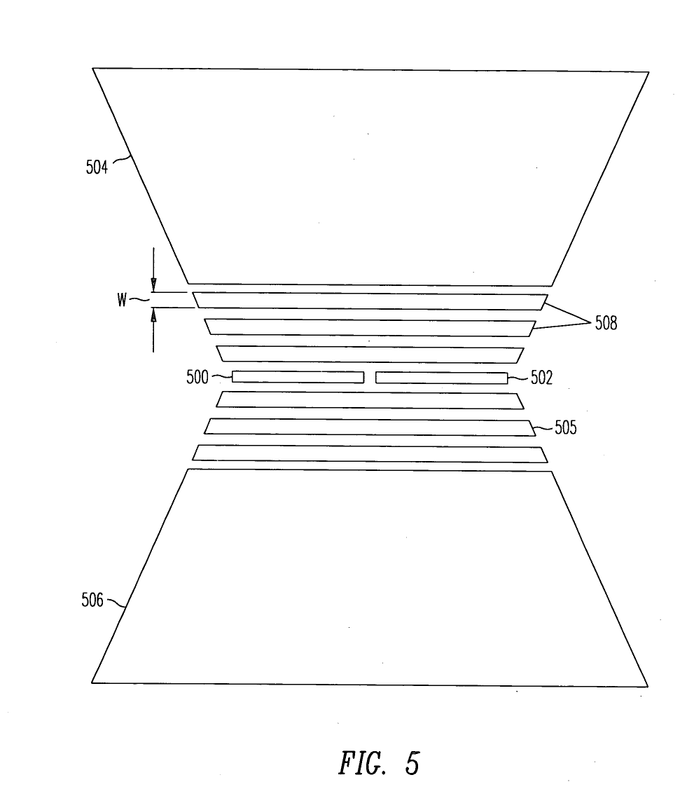

FIG. 5 shows a top view of a sensor arrangement of the invention comprising magnetoresistive sensors 500 and 502 as well as flux guides 504 and 506. Preferably sensors 500, 502 and flux guides 504, 506 are deposited on the same substrate (cf. substrate 301 of FIG. 4). Magnetoresistive sensors 500 and 502 can be similar to the sensor as shown in FIG. 1 or to the sensor of FIG. 4.

Flux guides 504 and 506 have flux guide stripes 508 in order to create magnetoelastic anisotropy. The flux guide stripes induce compressive stress parallel to the stripe direction when the temperature increases. For example flux guide stripes 508 consist of thin plated permalloy films such that magnetostriction caused by mechanical stress due to a temperature increase amplifies the magnetic flux which is directed by the flux guides 504 and 506 onto sensors 500 and 502.

Preferably the ratio of width W of a flux guide stripe 508 and its thickness in a direction perpendicular to the substrate is about three in order to create maximum stress anisotropy and flux amplification.

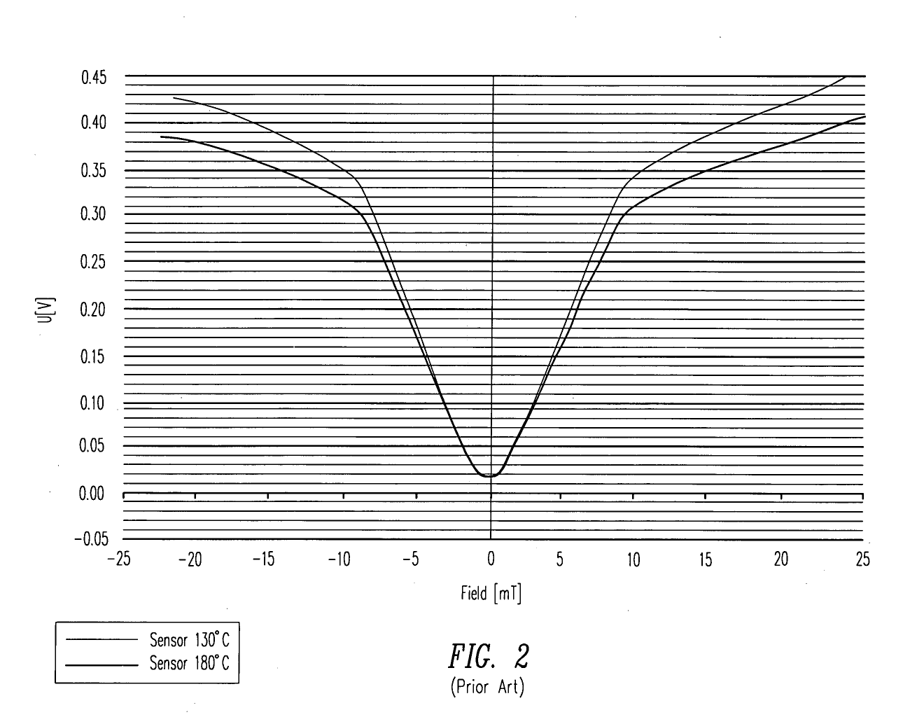

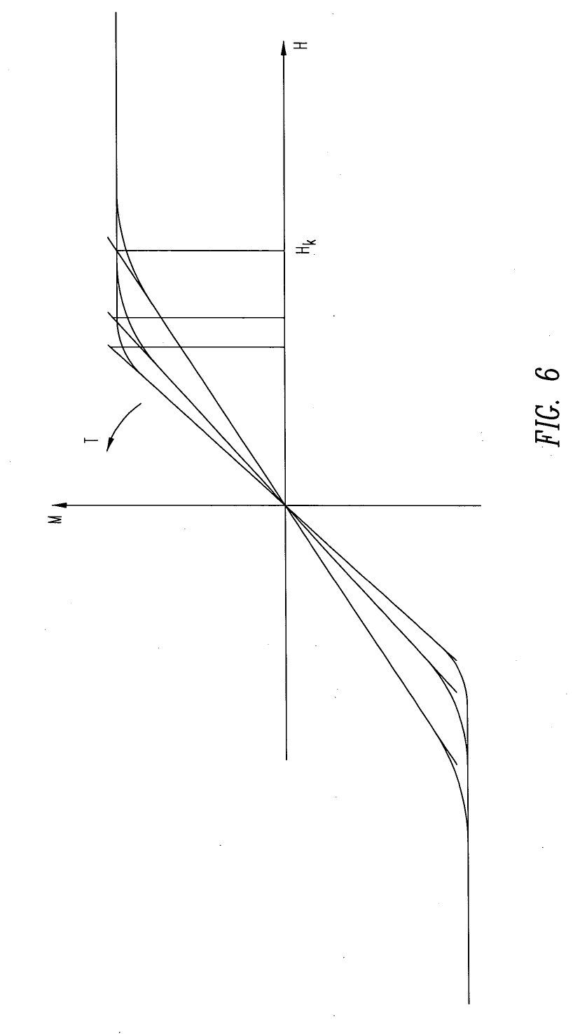

FIG. 6 illustrates the effect of magnetostriction on the magnetic flux M when the operating temperature T of the magnetoresistive sensor increases. As apparent from FIG. 6 the magnetic flux M is amplified due to the magnetostriction which compensates a decrease of sensitivity of the magnetoresistive sensor due to the temperature increase (cf. FIG. 2).

1. A magnetoresistive sensor comprising:
a substrate; and
a multilayer stack of at least first and second ferromagnetic layers being spaced apart by a non-ferromagnetic spacing layer, the stack being formed on the substrate, such that mechanical stress is created between at least one of the first and second ferromagnetic layers and the substrate when the operating temperature of the sensor increases; and
wherein said at least one ferromagnetic layer comprises a ferromagnetic element creating magnetoelastic anisotropy by which a magnetic flux to which the stack is subjected is amplified when the operating temperature of the stack increases.

2. The magnetoresistive sensor of claim 1, wherein the ferromagnetic element is made of permalloy.

3. The magnetoresistive sensor of claim 1, wherein the ferromagnetic element layers is made of Ni—Fe.

4. The magnetoresistive sensor of claim 3, wherein the Ni—Fe composition has less than 81.4% nickel.

5. The magnetoresistive sensor of claim 1, wherein the multilayer stack comprises a spin valve structure.

6. The magnetoresistive sensor of claim 1, wherein the ferromagnetic element consists of a ferromagnetic material having a positive magnetostriction and wherein the ferromagnetic element is arranged in parallel to the multilayer stack.

7. A magnetoresistive sensor comprising:
a substrate;
a multilayer stack of at least first and second ferromagnetic layers being spaced apart by a non-ferromagnetic spacing layer, the stack being formed on the substrate; and
at least one flux guide formed, the at least one flux guide having at least one flux guide stripe being substantially parallel to the multilayer stack, the flux guide and flux guide stripe being formed on the substrate such that mechanical stress is created between the least one flux guide stripe and the substrate when the operating temperature of the sensor increases; and
wherein said flux guide stripe comprises a ferromagnetic element creating magnetoelastic anisotropy by which a magnetic flux to which the stack is subjected is amplified when the operating temperature of the stack increases.

8. The magnetoresistive sensor of claim 7, wherein the ferromagnetic element is made of permalloy.

9. The magnetoresistive sensor of claim 7, wherein the ferromagnetic element layers is made of Ni—Fe.

10. The magnetoresistive sensor of claim 9, wherein the Ni-Fe composition has less than 81.4% nickel.

11. The magnetoresistive sensor of claim 7, wherein the multilayer stack comprises a spin valve structure.

12. The magnetoresistive sensor of claim 7, wherein the ferromagnetic element consists of a ferromagnetic material having a positive magnetostriction and wherein the ferromagnetic element is arranged in parallel to the multilayer stack.

13. A magnetoresistive sensor comprising:
a substrate;
a multilayer stack of at least first and second ferromagnetic layers being spaced apart by a non-ferromagnetic spacing layer, the stack being formed on the substrate; and
at least one flux guide formed, the at least one flux guide having at least one flux guide stripe being substantially perpendicular to the multilayer stack, the flux guide and flux guide stripe being formed on the substrate such that mechanical stress is created between the least one flux guide stripe and the substrate when the operating temperature of the sensor increases; and
wherein said flux guide stripe comprises a ferromagnetic element creating magnetoelastic anisotropy by which a magnetic flux to which the stack is subjected is amplified when the operating temperature of the stack increases.

14. The magnetoresistive sensor of claim 13, wherein the ferromagnetic element is made of permalloy.

15. The magnetoresistive sensor of claim 13, wherein the ferromagnetic element layers is made of Ni—Fe.

16. The magnetoresistive sensor of claim 13, wherein the multilayer stack comprises a spin valve structure.

17. The magnetoresistive sensor of claim 13, wherein the ferromagnetic element consists of a ferromagnetic material having a negative magnetostriction and wherein the ferromagnetic element is arranged perpendicular to the multilayer stack.
